(19) United States
(12) Patent Application Publication
(10) Pub. No.: US 2006/0129580 A1
(43) Pub. Date: Jun. 15, 2006

(54) Method and computer configuration for providing database information of a first database and method for carrying out the computer-aided formation of a statistical image of a database

(76) Inventors: Michael Haft, Zorneding (DE); Reimar Hofmann, Munchen (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/534,510

(22) PCT Filed: Oct. 21, 2003
(86) PCT No.: PCT/EP03/11655

§ 371 Date: Oct. 31, 2005

(30) Foreign Application Priority Data
Nov. 12, 2002 (DE) 102 52 445.9

(51) Int. Cl. G06F 17/00

(52) U.S. Cl. 707/101

(57) ABSTRACT

09 A first statistical image is formed for the first database whereby representing statistical correlations of the data elements contained in the first database. Afterwards, the first statistical image is stored in a server computer and transmitted from this server computer over a communications network to a client computer. The received first statistical image is processed by the client computer.

The invention relates to a method and a computer arrangement for providing database information of a first database, and to a method for the computer-aided formation of a statistical image of a database.

Nowadays it is virtually impossible to find any processes which run without the aid of a computer. Frequently, when a computer is used within the scope of a process, the process is monitored by means of the computer or process-specific data is at least recorded by the computer and logged, this being, for example, data relating to the individual process steps of the process and its results or intermediate results.

For example, a call center usually contains detailed records relating to when a call has been received in the call center, and what this call is, when the respective received call was processed by an employee of the call center, which other employee of the call center the call was possibly passed on to etc.

In addition, extensive log files in which data relating to the individual processes is stored are usually formed in the process automation operations.

A third field of application is telecommunications; for example in the switches of a mobile radio network, log data about the data traffic occurring in the switches is determined and stored.

Finally, log data about the data traffic, for example about the access frequency to information made available by the web server computer is also frequently formed in a web server computer.

If problems occur in the course of a process, the operator of the system on which the process is being executed will usually attempt in situ to find the cause of the problems which have occurred. If he is not successful in doing this, he returns to the manufacturer of the system. At the manufacturer's end it is necessary to find the cause of the problem in accessing the logged process data, generally the recorded log data of the system. Currently, a log file containing the log data is of a considerable size, frequently the order of magnitude of several dozen Gbytes. For this reason, such a log file can only be transmitted unsatisfactorily to the manufacturer of the system, for example using FTP (file transfer protocol). Even if sufficiently fast communications connections are available, it is difficult and expensive for the manufacturer of a system to store and process the log files for a relatively large number of customers.

In other fields there is also the need to transmit large amounts of data for analysis purposes, for example whenever large databases are publically accessible, in order to permit the public to do research using the database data. The database data may be data from (public) research projects (for example data of a gene database of a protein database), weather data, demographic data, data which is to be made available for the purpose of grid searching (in this case only a restricted group of authorized users). In particular, the field of biotechnology is of considerable interest nowadays. There are a large number of databases in this area.

In addition, for reasons of data protection it is frequently desirable if all the specific information of the database data is not passed on.

One known possible way of making available information of a database from a server computer to a client computer via a communications network is for diagnostic or statistical tools for analyzing the data contained in the databases to be installed directly in the servers, which tools can be used, for example, by employing a work server which is installed on the server computer and a web browser program which is installed on the client computer. For this purpose it is possible to use what are referred to as OLAP (on-line analytical processing) tools whose operation is however very costly and expensive. In some OLAP tools the quantity of data to be processed has even already become so large that the OLAP tools fail.

In addition for the operator of a system it is very inconvenient and expensive to operate these tools in the servers since it is, of course, the user of the client computer who is directly interested in the information, and the operator of the system is frequently not prepared to bear the additional costs for making available and maintaining the server computer and the OLAP tools.

Furthermore when there is a large number of client computers and a large number of inquiries to the server computer the responsibility for all the inquiries is very costly in terms of computing, for which reason the hardware of the server computer is frequently unacceptably expensive.

The invention is based on the problem of efficient access to the contents of a database via a communications network while maintaining the confidentiality of the data contained in the database.

The problem is achieved by means of a method and a computer arrangement for providing database information of a first database and by means of a method for the computer-aided formation of a statistical model of a database having the features according to the independent patent claims.

The general scenario which is addressed by the invention is characterized in the following way: a large quantity of data which is stored in the database is made available at a first location A. At a second location B, someone wishes to use this available data. The user at the location B is less interested in individual data records but is instead primarily interested in the statistics characterizing the database data.

In a method for the computer-aided provision of database information of a first database, a first statistical image, in the form of a common probability model, is formed of the first database. This image or model represents the statistical relationships between the data elements contained in the first database. The first statistical image is stored in a server computer. In addition, the first statistical image is transmitted from the server computer to a client computer via a communications network, and the received first statistical image is further processed by the client computer.

A computer arrangement for the computer-aided provision of database information of a first database has a server computer and a client computer which are coupled to one another by means of a communications network. A first statistical image, which is formed for a first database, is stored in the server computer. The first statistical image describes the statistical relationships between the data elements contained in the first database. The client computer is configured in such a way that it can be used to carry out further processing, for example to analyze, the first statistical map which is transmitted from the server computer to the client computer via the communications network.

In a method for the computer-aided formation of a statistical model of a database which has a plurality of data elements, it is possible to carry out what is referred to as an EM (Expectation Maximization) learning method on the data elements, as well as also alternatively other learning methods. The structure of the common probability model (comprising all the fields in the database) may be defined within the scope of the general formalism of the Bayesian networks (synonymously also causal networks or general graphic probabilistic networks). In this context, the structure is defined by means of a directional graph. The directional graph has nodes and edges, which relate the nodes to one another, with the nodes describing definable dimensions of the model or of the image corresponding to the values present in the database. Some of the nodes can also correspond here to non-observable variables (referred to as latent variables such as are described, for example, in [1]). Within the scope of a general EM learning method, absent or non-observable variables are replaced by expected values or expected distributions. Within the scope of the improved EM learning method according to the invention, only the expected values are determined for the missing variables whose parent nodes are observable values from the database.

A statistical model is preferably used as a statistical image.

In this context, a statistical model is to be understood as any model which represents all these statistical relationships or the common frequency distribution of the data of a database (precise or approximated), for example a Bayesian (or causal) network, a Markov network or generally a graphic probabilistic model, a “latent variable model”, a statistical clustering model or a trained artificial neural network. The statistical model may thus be embodied as a complete, precise or approximated image of the statistics of the database.

In the context of the further processing of the statistical model by the client computer this means that an analysis is not carried out on the basis of the data elements of the database itself or on the basis of an OLAP tool, as in the prior art. Instead, all the desired (conditional) likelihood distributions are determined from the common probability model, the statistical model.

This procedure according to the invention has, in particular, the following advantages:
compared to the database itself, the statistical model is very small since the statistical model is a compressed map of the statistics of the database (not of the individual entries in the database), comparable to a digital picture which is compressed according to the JPEG standard and which represents a compressed but approximated image of the digital picture;
the statistical model itself may be evaluated very quickly with significantly lower hardware expenditure.

Depending on the method used for training the statistical model it is possible to achieve considerable compression of the database. Using a learning method which can be scaled with the achievable compression, compression of up to a factor of 1 000 may be carried out, while the information contained in the statistical model was qualitatively sufficient. The compressed statistical models can thus very easily be transmitted from the server computer to the client computer by means, for example, of electronic email (e-mail), FTP (File Transfer Protocol) or other communication protocols for transferring data. The transmitted statistical model can thus be used for subsequent statistical analysis at the client end.

The server computer and the client computer can be coupled to one another via any communication network, for example via a fixed network or a mobile radio network, in order to transmit the statistical model.

The invention is suitable for use in any area in which it is desirable if the entire data for a large database is not transmitted but rather only a small quantity of data as possible is transmitted, while maintaining a largest possible information content of the data transmitted in terms of the database which is described by the transmitted data.

One advantage of the invention is to be seen in particular in the fact that it is made possible to ensure, to a high degree, the confidentiality of individual entries in the database since all the data elements of the database themselves are not transmitted but rather only a statistical representation of the data elements of the database, which permits statistical analysis of the database at the client end without the specific data, which is possibly to be kept secret, being available at the client end.

In addition, an operator of, for example, a technical system can make available the statistical contents of the database managed by him to a user of a client computer in an uncomplicated way and generally without infringing data protection guidelines, for example by means of a web server installed on the server computer, in which case the statistical models can be called by means of a web browser program installed on a client computer.

The invention may be implemented by means of software, that is to say by means of a computer program, using hardware, that is to say by means of a specific electronic circuit, or any desired hybrid form, that is to say partially using software and partially using hardware.

Preferred developments of the invention emerge from the dependent claims.

The following embodiments of the invention relate to the method and the computer arrangement.

According to one embodiment of the invention there is provision to use the first statistical model and data elements of a second database stored in the client computer to form an overall statistical model or an overall statistical image which has at least some of the statistical information contained in the first statistical image and some of the statistical information contained in the second database.

According to another embodiment of the invention there is provision to form, for a second database, a second statistical image or a second statistical model which represents the statistical relationships between the data elements contained in the second database. The second statistical image is transmitted to the client computer via the communications network and the first statistical image and the second statistical image are used by the client computer to form an overall statistical image which has at least some of the statistical information contained in the first statistical image and some of the statistical information contained in the second statistical image.

These embodiments of the invention allow, for example, for the following general scenario according to the invention in which almost every process in a company, in particular even each customer contact and each order and delivery of a product is carried out with computer assistance. In this context, the processes in the company or any action of a customer are recorded in detail in a log file, for example within the scope of what are referred to as Customer Relationship Management systems (CRM systems) or within the scope of supply chain management systems. The logged data constitutes a considerable resource for many companies. Correspondingly, there is an apparent trend in companies that they convert their data, for example data about customers into “knowledge about customers”. It has become apparent however that the information about, for example, a customer which is available in a company, but also about the operation of a technical system or like, is only very one-sided. Significant attributes of all the customers or of individual customers or technical systems which actually permit, for example, target group-focused marketing, generally high-quality data evaluation are often absent. One example in the field of customer information is the age of the customer or his family status or number of children. However, it has became apparent that when the information from a plurality of databases is combined, whether customer databases or else databases with information about technical processes, a considerably more precise and more complete “picture” (in the case of marketing a “customer picture”) is obtained. The common use of the databases or of the knowledge of a plurality of companies would thus permit a considerable improvement for the subsequent evaluation. However, the exchange of data beyond the boundaries of company does not present a satisfactory solution for the problem described above for the following reasons:
companies are usually not prepared to pass on details about their customers or their technical processes to other companies. The clientele of a company and thus the detailed data about the customers frequently constitutes an essential company resource.
Exchanging the database data means in technical terms that large quantities of data have to be transmitted and stored.
For reasons of data protection law, tight limits are placed on database data exchange, in particular data relating to persons.
Even if data is exchanged between two companies, in the first instance, unless there are additional measures, an improved picture is produced only for the customers who are known in both companies. For customers who are known in only one company the data remains incomplete, as does thus also the picture of these customers.

To summarize, the following aspects according to the invention are thus clearly obtained:
knowledge about customers or processes or systems, generally the information contained in a database, is presented in such a way
   that it is highly compressed and thus can be exchanged in a technically easier way between the computers, and
   that significant relationships are displayed, but that detailed information can be found again only to a definable degree so that companies exchange such information with fewer reservations and data protection guidelines are not infringed.
The information which is presented in this way and which arises from different sources (from different databases) can be combined to form an overall image which can be used by all the participating companies.

The embodiments described above thus make it possible to make the statistical information available to the users who can combine the statistical models at the client end to form an overall picture, the overall model, while preserving data protection and reducing the required bandwidth for the transmission of the statistical information.

According to another embodiment of the invention, the statistical models are stored in different server computers and are each transmitted from there to the client computer via a communications network.

In this context it is to be noted that the statistical models can be formed by the server computer or computers, and alternatively also by other computers which are possibly specially set up for that purpose, in which case the statistical models which are formed are also transmitted to the server computer or computers, for example via a local network.

As a result, the statistical models can very easily be made available worldwide in a heterogeneous network, for example on the Internet.

At least one of the statistical models can be formed by means of a scalable method with which the degree of compression of the statistical model is compared to the data elements contained in the respective database can be adjusted.

At least one of the statistical models can also be formed by means of an EM learning method or variants thereof (such as are described, for example, in [2]) or by means of a gradient-based learning method. For example, what is referred to as the APN (Adaptive Probabilistic Network) learning method can be used as the gradient-based learning method. Generally, all the likelihood-based learning methods or Bayesian learning methods such are described, for example, in [3] can be used. The structure of the general probability models may be specified here in the form of a graphic probabilistic model (a Bayesian network, a Markov network or a combination thereof). What are referred to as latent variable models or statistical clustering models correspond to a specific case of this general formalism. Furthermore, any method for learning not only the parameters but also the structure of graphic probabilistic models from available data elements can be used, for example any desired structure learning method [4] and [5].

The first database and/or the second database can have data elements which describe at least one technical system. The data elements describing the at least one technical system may represent values which are measured at least partially on the technical system and which describe the operating behavior of the technical system.

According to one configuration of the computer arrangement according to the invention, a second database with data elements is stored in the client computer. The client computer has a unit for forming an overall statistical model using the first statistical model and the data elements of the second database, with the overall statistical model having at least some of the statistical information contained in the first statistical model and some of the statistical information contained in the second database.

According to another configuration of the computer arrangement according to the invention, a second server computer is provided in which a second statistical model, which is formed for a second database, is stored, wherein the second statistical model represents the statistical relationships between the data elements contained in the second database. The client computer is also coupled to the second server computer by means of the communications network. The client computer has a unit for forming an overall statistical model using the first statistical model and the second statistical model, wherein the overall statistical model has at least some of the statistical information contained in the first statistical model and some of the statistical information contained in the second statistical model.

An exemplary embodiment of the invention is illustrated in the figures and will be explained in more detail below.

In the figures:

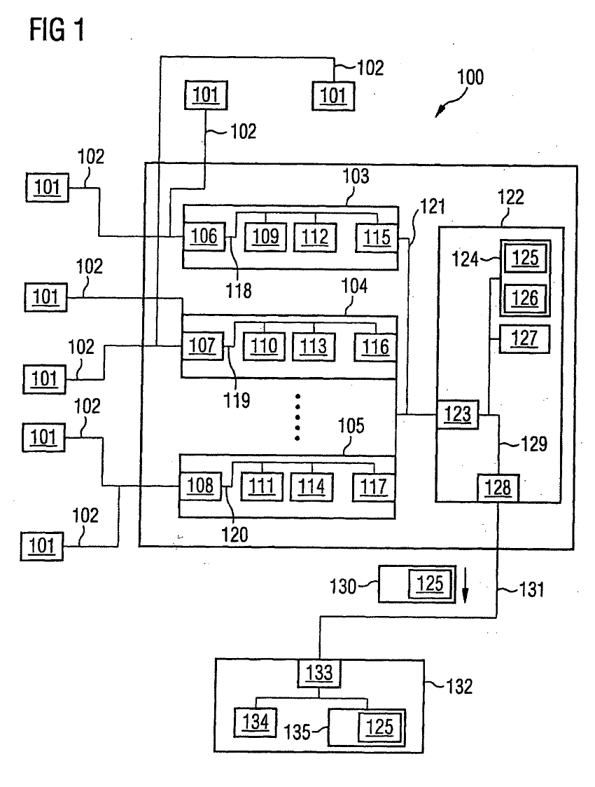

FIG. 1 is a block diagram of a computer arrangement according to a first exemplary embodiment of the invention;

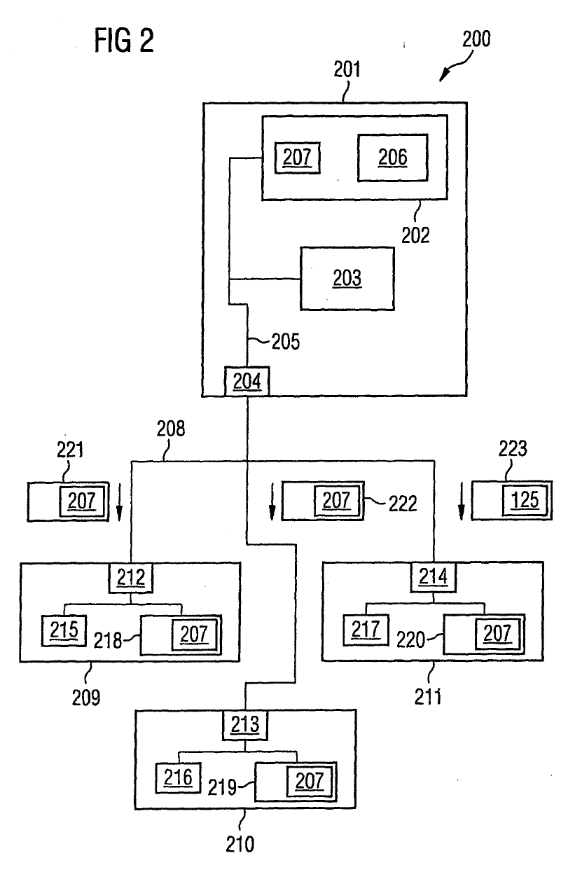

FIG. 2 is a block diagram of a computer arrangement according to a second exemplary embodiment of the invention;

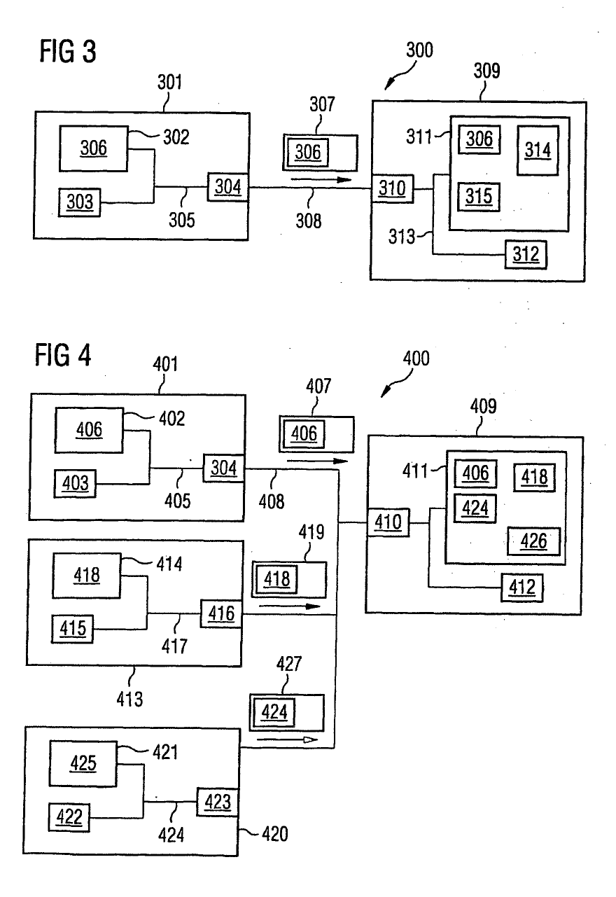

FIG. 3 is a block diagram of a computer arrangement according to a third exemplary embodiment of the invention;

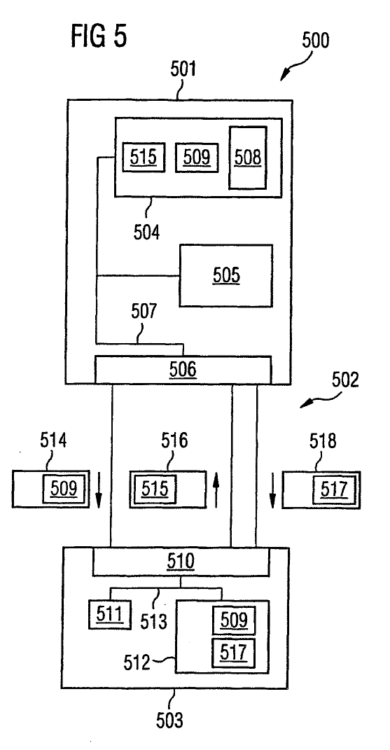

FIG. 4 is a block diagram of a computer arrangement according to a fourth exemplary embodiment of the invention; and

FIG. 5 is a block diagram of a computer arrangement according to a fifth exemplary embodiment of the invention.

FIG. 1 shows a computer arrangement 100 according to a first exemplary embodiment of the invention.

The computer arrangement 100 is used in a call center. The computer arrangement 100 has a plurality of telephone terminals 101 which are connected to a call center computer 103, 104, 105 by means of telephone lines 102. In the call center, the telephone calls are received by employees of the call center and the processing of the incoming telephone calls, in particular the time of the incoming call, the duration, information about the employee who has received the call, information about the reason for the call and the type of processing of the call or any desired other information are recorded by the call center computers 103, 104, 105.

Each call center computer 103, 104, 105 has
a first input/output interface 106, 107, 108 with the public telephone network for receiving the respective telephone call,
a processor 109, 110, 111,
a memory 112, 113, 114, and
a second input/output interface 115, 116, 117 with a local network 121 of the call center.

The abovementioned components within each call center computer 103, 104, 105 are coupled to one another by means of a computer bus 118, 119, 120.

The call center computers 103, 104, 105 are coupled to a server computer 122 by means of the local network 121. The server computer 122 has a first input/output interface 123 with the local network 121, a memory 124, a processor 127 and a second input/output interface 128 which is configured for communication over the Internet, which components are coupled to one another by means of a computer bus 129. According to this exemplary embodiment, the server computer 122 serves as a web server computer, as is also explained in more detail below.

The data which is recorded by the call center computers 103, 104, 105 is transmitted via the local network 121 to the server computer 122 and stored there in a database 126.

In addition, a statistical model 125, which represents the statistical relationships between the data elements contained in the database 126, is also stored in the memory 124.

The statistical model 125 is formed using the EM learning method which is known per se. Other alternative, preferably used methods for forming the statistical model 125 will also be described in detail below.

According to this exemplary embodiment of the invention, the statistical model 125 is re-formed automatically at regular time intervals, in each case on the basis of the most up-to-date data of the database 126.

The statistical model 125 is automatically made available by the server computer 122 for transmission to one or more client computers 132. The client computer 132 is coupled to the second input/output interface 128 of the server computer 122 via a second communications link 131, for example a communications link which permits communication according to the TCP/IP communication protocol.

The client computer 132 also has an input/output interface 133, configured for communication according to the TCP/IP communications protocol, as well as a processor 134 and a memory 135.

The statistical model 125 which is transmitted in an electronic message 130 from the server computer 122 to the client computer 132 is stored in the memory 135 of the client computer 132. The user of the client computer 132 then carries out any desired, user-specific statistical analysis on the statistical model 125 and thus “indirectly” on the data of the database 126 without the large database 126 having to be transmitted to the client computer 132.

The object of the client-end statistical analysis may be to optimize the call center. According to this exemplary embodiment, in particular analyses regarding the response to the following questions are carried out:

“How long does a telephone caller usually wait in a queue of the call center before giving up?”

“Are there regional or daily relationships between the telephone calls received at the call center?”

“At what time and according to which other features do which inquiries occur and how many operators should accordingly be made available in the call center?”

“Which routing strategies lead to which results?”

As a result, the analyses are carried out in order to respond to the abovementioned questions by the user of the client computer 132. The results of the analyses then provide the operator of the call center with suitable measures for optimized operation of the call center.

FIG. 2 shows a computer arrangement 200 according to a second exemplary embodiment of the invention.

The computer arrangement 200 is used in the field of biotechnology.

The computer arrangement 200 has a server computer 201 which has a memory 202, a processor 203 and an input/output interface 204 which is configured for communication according to the TCP/IP protocols. The components are coupled to one another by means of a computer bus 205.

A database 206 with genetic sequences or amino acid sequences is stored together with the sequences of assigned additional information in the memory 202.

For a researcher, according to this exemplary embodiment a user of one of the client computers 209, 210, 211 who is investigating the properties of a (new) sequence, it is frequently of considerable interest to find sequences with identical or similar properties. In order to search through the databases made available publically by the server computer or computers 201, the researcher uses the client computer 209, 210, 211 which is coupled to the server computer 201 via a communications network 208 to pose corresponding search inquiries to the server computer or computers 202. A statistical model 207 is formed in the server computer 201 in the same way as according to the first exemplary embodiment and stored there.

Each client computer 209, 210, 211 has
an input/output interface 212, 213, 214 which is configured for communication according to the TCP/IP protocols,
a processor 215, 216, 217
a memory 218, 219, 220.

After a client computer 209, 210, 211 has submitted an inquiry, the server computer 201 transmits the statistical model 206 to the client computer 209, 210, 211 in an electronic message 221, 222, 223.

After the statistical model 206 has been received, the user of the client computer 209, 210, 211 compares the sequence to be investigated by him with the statistical model 206. The result of a statistical analysis is information about how many sufficiently similar sequences there are in the database 206 and which properties distinguish these sequences.

FIG. 3 shows a computer arrangement 300 according to a third exemplary embodiment of the invention.

The computer arrangement 300 has a first computer 301 and a second computer 309.

The first computer 301 has a memory 302, a processor 303 and an input/output interface 304 which is configured for communication according to the TCP/IP communication protocols and which are coupled to one another by means of a computer bus 305.

The first computer 301 is a computer of a car dealer which contains, in the customer database stored in the memory 302, information about the given name and family name of the customers, about the address and type of vehicle used, but not about the age, family status or salary.

The second computer 309 has an input/output interface 310 which is configured for communication according to the TCP/IP communications protocols, a memory 311 and a processor 312, which are coupled to one another by means of a computer bus 313.

The second computer 309 is a computer of a bank which works with the car dealer. A second customer database 314 is stored in the memory 311 of the second computer 309. The second customer database 314 contains information about the customers of the bank in terms of the given name and family name of the customers, their address, family status, age and salary but not however about the type of vehicle used by the respective customer. From the bank's stored data it is therefore impossible for it to determine which families with which salary typically use which car.

In order to obtain this information, it would be necessary to combine the two customer databases, but this is not permitted for reasons of data protection law and is also usually not desired by the two companies.

According to the invention, use is made of the fact that in both databases the knowledge is in any case present in approximated fashion in order to form a relationship between, for example, the type of vehicle and salary.

For this reason, in the first computer a statistical model 306 is formed by means of the database using the EM learning method. The statistical model 306 which is compressed compared to the database is transmitted in an electronic message 307 to the second computer 309 which is coupled to the first computer 301 bidirectionally via the Internet 308.

After the statistical model 306 has been received, it is combined by the second computer 309 with the second customer database 314 to form an overall statistical model 315.

In order to explain the combination of the statistical model 306 with the second customer database 314 to form the overall statistical model 315 it is assumed that two parties A and B wish to exchange statistical models. The party A has the attributes W, X, Y which are symbolic of a large number of random attributes. The party B has the attributes X, Y, Z. The party B (according to this exemplary embodiment the car dealer) provides the party A (according to this exemplary embodiment the bank) with a statistical model of its data, which is referred to below by P_{B}(X,Y,Z).

The objective of the party A is to generate an overall statistical model P(W,X,Y,Z) from its data together with the data of its database.

For this purpose, the following two methods are provided according to this exemplary embodiment:
the party A derives a conditional model P_{B}(Z|X,Y) from the statistical model P_{B}(X,Y,Z) in order to use it to estimate the property Z of its customers from the information X and Y known to it about its customers. Each customer is assigned, as a value of the variable Z (as an entry in an additional column in the database), the value which is most probable according to the likelihood distribution P_{B}(Z|X,Y). With the information W, X, Y and Z which are supplemented in this way, about each customer the party A can then apply customary statistical analytical methods with respect to all four attributes or can generate a common statistical model, the overall model P_{B}(W,X,Y,Z), which clearly represents a virtual common database image.

Instead of supplementing the most probable value for the attribute Z, in an alternative procedure it may be more appropriate to supplement an entire distribution over its values instead of the missing variable Z and to use it when generating the overall statistical model. The EM learning method is used in this context in order to handle partially missing information in a statistically consistent fashion in terms of what is referred to as the likelihood of a model. In each learning step of the iterative EM learning method, estimations (expected sufficient statistics) about the missing variables, which take the place of the missing variables, are generated on the basis of the current parameters. The conditional model P_{B}(Z|X,Y) can also be used in the EM learning method for determining expected values or expected sufficient statistics values for the variable Z, and thus for expanding this learning method in a consistent fashion in order to generate a common model of distributed data.

The bank therefore has the entire statistical information available and can carry out corresponding analyses by means of the data.

In this context it is to be noted that the scenario described above can also be carried out conversely, i.e. the bank produces a statistical model by means of the second customer database and transmits it to the car dealer which itself forms an overall statistical model. For the car dealer it would be desirable, for example, to know the age of its customers, their family status and their salary, or at any rate an estimation of the age, the family status and the salary. On the basis of this information, suitable products may then be offered to the customers in a much more targeted fashion, for example it is certainly appropriate to offer a different car to a young family with an average salary than to a single person with a high salary.

FIG. 4 shows a computer arrangement 400 according to a fourth exemplary embodiment of the invention.

According to this exemplary embodiment, a plurality of n computers 401, 413, 420 are provided, each of these computers having a customer database in accordance with the third exemplary embodiment.

The first computer 401 has a memory 402, a processor 403 and an input/output interface 404 which is configured for communication according to the TCP/IP communication protocols and which are coupled to one another by means of a computer bus 405.

The first computer 401 is a computer of a car dealer which contains, in the customer database stored in the memory 402, information about the given name and family name of the customers, about the address and type of vehicle used, but not about the age, family status and salary.

By means of the customer database, the first computer 401 forms a first statistical model 406 and stores it in the memory 402.

The second computer 413 has a memory 414, a processor 415 and an input/output interface 416 which is configured for communication according to the TCP/IP communication protocols and which are coupled to one another by means of a computer bus 417.

The second computer 413 is a computer of a bank which contains the information mentioned in the third exemplary embodiment, in the customer database which is stored in the memory 414. A second statistical model 418 is formed by the second computer 413 by means of the second customer database, and is stored in the memory 414.

The n-th computer 420 also has a customer database stored in it. The n-th computer 420 has a memory 421, a processor 422 and an input/output interface 423 which are configured for communication according to the TCP/IP communication protocols and which are coupled to one another by means of a computer bus 424. A statistical model 425 is also formed in the n-th computer 420 using the customer database by means of the EM learning method and thus stored in the memory 421 of the n-th computer 420.

The computers 401, 413, 420 are coupled to a client computer 409 by means of a respective communications connection 408.

The client computer 409 has a memory 411, a processor 412 and an input/output interface 410 which is configured for communication according to the TCP/IP communication protocols and which are coupled to one another by means of a computer bus 426.

The computers 401, 413, 420 transmit the statistical models 406, 418, 525 to the client computer 409 in respective electronic messages 407, 419, 427 which stores them in its memory 410.

In the text which follows, for the sake of simpler presentation the exemplary embodiment is explained in more detail only with respect to the first statistical model 406 and the second statistical model 418. However, it is to be noted that according to the invention any desired number of statistical models may be combined to form an overall model, for example by means of repeated execution of the method steps described below.

In contrast to the third exemplary embodiment, the objective according to the third exemplary embodiment is to combine a plurality of statistical models with one another to form an overall model.

Therefore, by analogy with the nomenclature used in the third exemplary embodiment a statistical model P_{A}(W,X,Y) is also produced by the party A and the models P_{A}(W,X,Y) and P_{B}(X,Y,Z) are then combined to form an overall statistical model P(W,X,Y,Z).

The overall model P(W,X,Y,Z) can be defined on the basis of the two models P_{A}(W,X,Y) and P_{B}(X,Y,Z) as:
P(W,X,Y,Z)=P_{A}(W,X,Y)P_{B}(Z|X,Y) or as
P(W,X,Y,Z)=P_{B}(X,Y,Z)P_{A}(W|X,Y).

The invention also provides combinations of the two procedures. For the party A it is most appropriate to select the first alternative above. As a result he has an overall statistical model 426 which permits him, in an approximated way, also to analyze the dependencies between the attributes W and Z (in this exemplary embodiment the dependency between the type of vehicle and salary). On the basis of the overall model 426, for example, conditional likelihood distributions of the form P(X|Z), for example a distribution over or an affinity with types of vehicle given a certain salary is determined. For this purpose, marginalization is carried out over the variables X and Y.

For the sake of explanation it is assumed that the results from the overall model 426 are obtained in a type of two-stage process. At first, the common variables X and Y are inferred from the variable W on the basis of the model P_{A}(W,X,Y) Corresponding to all the combinations thereafter allowed for the variables X and Y, the conditional likelihood distribution P_{B}(Z|X,Y) (prediction of the variable Z from the variables X and Y) is used to determine the distribution for the variable Z.

In contrast to the case in which all four variables can be found in one database, according to the invention the conclusion is thus arrived at indirectly, and information may be lost in the process, as in the case of the whispering post.

In the worst case, specifically when there is no overlap between the two statistical images, it is also impossible to combine the two models. However, for example in the case in which common variables are present in the two models it is possible to form an overall model even if there are common customers, for example no common customer key, in the two output databases.

The overall model 426 P(W,X,Y,Z) may be held in a numerically simple way if the overlap between these statistical models is not too large, preferably less than 10 common variables. If there is a large “overlap space”, additional approximations may be used to speed up the execution of the following sums which according to the exemplary embodiments above have to be formed over all the common states of the common variables X and Y:

$$P ( W \vert Z ) ∝ {\sum }_{x , y} {P}_{A} ( W , X , Y ) \cdot {P}_{B} ( Z \vert X , Y )$$

$$or$$

$$P ( W , Z ) = {\sum }_{x , y} {P}_{A} ( W , X , Y ) \cdot {P}_{B} ( Z \vert X , Y ) .$$

The sums may in particular be approximated in a very skillful fashion on the basis of an approach by introducing an additional artificial variable H and additional, conditional distributions (tables in the case of a discrete variable) P(H|X,Y) and P(Z|H) in the form:

$${P}_{approx} ( W , Z ) \approx {\sum }_{x , y} {P}_{A} ( W , X , Y ) {\sum }_{h} P ( H \vert X , Y ) \cdot {P}_{B} ( Z \vert H )$$

$$or$$

$${P}_{approx} ( W , X , Y , Z ) \approx {P}_{A} ( W , X , Y ) {\sum }_{h} P ( H \vert X , Y ) \cdot {P}_{B} ( Z \vert H ) .$$

The structure or the parameterization of the conditional distributions P(H|X,Y) and P(Z|H) or the form of the dependency between X,Y and H on the one hand and H and Z on the other is selected in such a way that the sums above can be carried out easily. The parameters of the conditional distributions P(H|X,Y) and P(Z|H) are determined in such a way that the approximated overall distribution Pₐₚₚᵣₒₓ(W,X,Y,Z) corresponds as well as possible to the desired distribution
P(W,X,Y,Z)=P_{A}(W,X,Y)·P_{B}(Z|X,Y)

In particular the log likelihood or the Kullback-Leibler distance may be used here as the cost function. Therefore once more an EM learning method or a gradient-based learning method are appropriate as optimization methods.

Finding optimal parameters can and may be extremely complex in terms of calculations. As soon as the two probability models are then “merged” to form one overall model, the overall model can be used in a very efficient way.

It is appropriate in particular to introduce the variable H as a concealed variable, that is to say to parameterize the distribution P(W,X,Y,H) as
P(W,X,Y,H)=P(H)·P(W,X,Y|H)
with what is referred to as an a priori distribution P(H).

In the case in which the model P(W,X,Y) has already been originally parameterized as a latent variable model

$${P}_{A} ( W , X , Y ) = {\sum }_{h} {P}_{A} ( X , Y , Z \vert H ) \cdot {P}_{A} ( H ) ,$$

the already present latent variable H may be used directly.

Instead of a concealed variable H it is also possible to introduce a plurality of variables. At the same time, a concealed variable K may also be introduced for the model PB in order to simplify the numerics. An approximation of the overall model P(W,X,Y,Z) thus assumes, for example, the form

$$P ( W , X , Y , Z ) \approx {\sum }_{h} {P}_{A} ( X , Y , Z \vert H ) \cdot {P}_{A} ( H ) {\sum }_{k} P ( K \vert H ) \cdot {P}_{B} ( Z \vert K ) .$$

In this model, sums can easily be carried out over the space of the overlap composed of X and Y by means of known interference methods (for example what is referred to as the junction-tree method). In order to merge the two models all that is necessary is to determine the conditional distribution P(K|H) by means of known learning methods.

In order to achieve the objective of generating small, interchangeable but very precise “images of a database”, in particular very scalable learning methods, which generate highly compressed images, are desirable. At the same time, the images should merge, i.e. be combined, efficiently, for which purpose in particular missing information should also be handled very efficiently. Known learning methods are slow in particular if many of the assignments of the fields are missing in the data.

FIG. 5 shows a computer arrangement 500 according to a fifth exemplary embodiment of the invention.

The computer arrangement 500 is used within the scope of the exchange of customer information, according to this exemplary embodiment within the scope of exchange of address information of customers. The computer information 500 has a server computer 501 and one or more client computers 503 which are connected to the latter via a telecommunications network 502.

The server computer 501 has as memory 504, a processor 505 and an input/output interface 506 which is configured for communication over the Internet, which components are coupled to one another by means of a computer bus 507. According to this exemplary embodiment the server computer 501 serves as a web server computer, as will be explained in more detail below.

A large customer database 508 (in particular with address information about the customers and information describing the purchasing behavior of the customers) is stored in the memory 504. In addition, a statistical model 509, which has been formed by the server computer 501 by means of the customer database 508 and which represents the statistical relationships between the data elements contained in the customer database 508 is also stored in the memory 504.

The statistical model 509 is formed using an EM learning method known per se. Other alternative, preferably used methods for forming the statistical model 509 will also be described in detail below.

According to this exemplary embodiment of the invention, the statistical model 509 is re-formed automatically at a regular, predefined time intervals, in each case on the basis of the most up-to-date data of the customer database 508.

The statistical model 509 is automatically made available by the server computer 501 for transmission to the one or more client computers 503.

The client computer 503 also has an input/output interface 510, configured for communication according to the TCP/IP communication protocol, as well as a processor 511 and a memory 512. The components of the client computer are coupled to one another by means of a computer bus 513.

The statistical model 509 which is transmitted in an electronic message 514 from the server computer 501 to the client computer 503 is stored in the memory 512 of the client computer 503.

In this context it is to be noted that the statistical model 509 does not contain the details of the customer database 508, in particular the actual addresses of the customers. However, the statistical model 509 contains statistical information about the behavior, in particular about the purchasing behavior, of the customers.

The user of the client computer 503 then selects a group of customers which is of interest to him, i.e. a part 515 of the statistical model 509 which is of interest to him and which describes a purchasing behavior which is of interest to the company of the user of the client computer 503. The information 515 about the selected part of the statistical model 509 is transmitted by the client computer 503 in a second electronic message 516 to the server computer 501.

The server computer 501 uses the received information to read out the customers designated by means of the part 515 of the statistical model 509, and associated customer detailed information 517, in particular the addresses of the customers, from the customer database 508 and transmits the read-out customer detailed information 517 in a third electronic message 518 to the client computer 503.

In this way, it is possible, for example for a marketing campaign by the user of the client computer 503, to select in a targeted fashion the addresses of the customers of the company of the server computer 501 which are of interest for the campaign according to the customer database 508 and to request them from the server computer 501. A considerable advantage is also the fact that the server computer 501 only transmits the client computer 503 the information which is actually allowed to be transmitted to it.

According to one embodiment of the invention this transmission is carried out for payment. In other words, in this way a very efficient, so-called “on-line list broking” system is realized.

Various scalable methods performing a statistical model are specified below.

For the sake of better understanding of the preferably used improvement in an EM learning method in the case of a naïve Bayesian cluster model, a number of principles of the EM learning method will be explained in more detail below:

A set of K statistical variables (which may correspond, for example, to the fields of a database) are referred to by X={Xₖ, k=1, . . . , K}.

The states of the variables are referred to by lower case letters. The variable X₁ may assume the states x_{1,1},x_{1,2}, . . . , i.e. X₁∈{x_{1,i}, i=1, . . . , L₁}. L₁ is the number of states of the variable X₁. An entry in a data record (of a database) is then composed of values for all the variables, where x^{π}≡(x₁^{π,x}₂^{π},x₃^{π}, . . . ) designates the π-th data record. In the π-th data record, the variable X₁ is in the state x₁^{π}, the variable X₂ is in the state x₂^{π} etc. The table has M entries, i.e. {x^{π}, π=1, . . . , M}. In addition, there is a concealed variable or a cluster variable which is referred to below by Ω and their states are {ωᵢ, i=1, . . . , N}. There are thus N clusters.

In one statistical clustering model, P(Ω) describes an a priori distribution; P(ωᵢ) is the a priori weighting of the i-th cluster and P(X|(ωᵢ) describes the structure of the i-th cluster or the conditional distribution of the observable variables (those contained in the database) X={Xₖ, k=1, . . . , K} in the i-th cluster. The a priori distribution and the conditional distributions for each cluster together parameterize a common probability model to X∪Ω or to X.

In a naïve Bayesian network it is a precondition that p(X|ωᵢ) can be factorized by

$${\prod }_{k = 1}^{K} p ( {X}_{k} \vert {ω}_{i} ) .$$

In general the aim is to determine the parameters of the model, that is to say the a priori distribution p(Ω) and the conditional likelihood tables p(X|Ω) in such a way that the common model reflects the input data as satisfactorily as possible. A corresponding EM learning method is composed of a series of iteration steps, with an improvement in the model (in the sense of a so-called likelihood) being achieved in each iteration step. In each iteration step the new parameters p^{new}( . . . ) are estimated on the basis of the current or “old” parameters p^{old}( . . . )

Each EM steps starts initially with the E step in which “sufficient statistics” are determined in tables which are provided for that purpose. The process is begun with likelihood tables whose entries are initialized with zero values. The fields of the tables are sealed in the course of the E step with the so-called sufficient statistics S(Ω) and S(X,Ω) by supplementing the missing information (that is to say in particular the assignment of each data point to the clusters) with expected values for each data point.

In order to calculate expected values for the cluster variable Ω the a posteriori distribution p^{old}(wᵢ|x^{π}) has to be determined. This step is also referred to as an “inference step”.

In the case of a naïve Bayesian network the a posteriori distribution for Ω has to be calculated according to the rule

$${p}^{old} ( {w}_{i} \vert {\underline{x}}^{π} ) = \frac{1}{{z}^{π}} {p}^{old} ( {w}_{i} ) {\prod }_{k = 1}^{K} {p}^{old} ( {x}_{k}^{π} \vert {ω}_{i} )$$

for each data point x^{π} from the input information, where

$$\frac{1}{{Z}^{n}}$$

is a predefinable scaling constant.

The essential part of this calculation is the formation of the product p^{old}(xₖ^{π}|ωᵢ) over all k=1, . . . , K. This product must be formed in each E step for all clusters i=1, . . . , N and for all the data points x^{π}, π=1, . . . , M.

Similarly complex and often even more complex is the inference step for the assumption of other dependent structures as a naïve Bayesian network, and it thus contains the essential numerical expenditure of the EM learning process.

The entries in the tables s(Ω) and S(X,Ω) change after the formation of the above product for each data point x^{π}, π=1, . . . , M since S(ωᵢ) has p^{old}(ωᵢ|x^{π}) added to it for all i, or a sum of all p^{old}(ωᵢ|x^{π}) is formed. In a corresponding way, S(x,ωᵢ) (or S(xₖωᵢ) for all the variables k in the case of a naïve Bayesian network) has in each case p^{old}(ωᵢ|x^{π}) added to it for all the clusters i. This terminates the E (expectation) step initially.

By reference to this step, new parameters p^{new}(Ω) and p^{new}(x|Ω) are calculated for this statistical model, with p(x|ωᵢ) representing the structure of the i-th cluster or the conditional distribution of the variables x, contained in the database, in this i-th cluster.

In the M (maximization) step, by optimizing a general log likelihood

$$L = {\sum }_{π = 1}^{M} log {\sum }_{i = 1}^{N} p ( {\underline{x}}^{π} \vert {ω}_{i} ) p ( {ω}_{i} ) \qquad ( 1 )$$

new parameters p^{new}(Ω) and p^{new}(x|Ω) based on the already calculated sufficient statistics are formed.

The M step no longer entails any significant numerical complexity.

It is thus clear that the main complexity of the algorithm lies in the inference step or in the formation of the product

$${\prod }_{k = 1}^{K} {p}^{old} ( {x}_{k}^{π} \text{\vert} {ω}_{i} )$$

and in the accumulation of the sufficient statistics.

The formation of numerous zero elements in the likelihood tables p^{old}(X|ωᵢ) or p^{old}(Xₖ|ωᵢ) can however be utilized for calculating the product efficiently by skillful data structures and storage of intermediate results from one EM step to the next.

In order to accelerate the EM learning method, the formation of an overall product is carried out as usual in an inference step above which is formed from factors of a posteriori distributions of membership probabilities for all the input data points, but as soon as the first zero occurs in the associated factors the formation of the overall product is aborted. It can be shown that if a cluster is assigned the weighting zero for a specific data point in an EM learning process, this cluster is also assigned to the weighting zero in all the other EM steps for this data point.

This ensures an appropriate elimination of excess numerical complexity by buffering corresponding results from one EM step to the next and processing them only for the clusters which do not have the weighting zero.

This thus results in the advantages that owing to the aborting of the processing when a cluster occurs with zero weightings the EM learning method is significantly accelerated overall not only within an EM step but for all the other steps, in particular during the formation of the product in the inference step.

In a method for determining a likelihood distribution which is present in predefined data, membership probabilities for specific classes are calculated only up to around the 0 in an iterative method, and the classes with membership probabilities below a selectable value are no longer used in the iterative method.

In one development of the method, a sequence of factors to be calculated is determined in such a way that the factor which is associated with a rarely occurring state of a variable is processed first. The rarely occurring values can be stored in an assigned list before the start of the formation of the product in such a way that the variables are arranged in the list in accordance with the frequency with which a zero appears in them.

It is also advantageous to use a logarithmic representation of likelihood tables.

It is also advantageous to use a sparse representation of the likelihood tables, for example in the form of a list which contains only the elements which are different from zero.

In addition, when calculating sufficient statistics only the clusters which have a weighting different from zero are taken into account.

The clusters which have a weighting different from zero may be stored in a list, with the data which is stored in the list being able to be pointers to the corresponding clusters.

The method may also be an expectation maximization learning process in which, in the case of a cluster having an a posteriori weighting of “zero” assigned to it for a data point this cluster receives the weighting zero in all the other steps of the EM method for this data point and this cluster no longer has to be taken into account in all the other steps.

The method may also run here only via clusters which have a weighting which is different from zero.

I. First Example in an Inference Step

a) Formation of an Overall Product with Interruption at the Zero Value

An overall product is formed for each cluster ωᵢ in an inference step. As soon as the first zero occurs in the associated factors, which may be read out, for example, from a memory, array or a pointer list, the formation of the overall product is aborted.

If a zero point occurs, the a posteriori weighting which is associated with the cluster is then set to zero. Alternatively it is also possible firstly to check whether at least one of the factors in the product is zero. In this context, all the multiplications for the formation of the overall product are carried out only if all the factors are different from zero.

If, on the other hand, a zero value does not occur in a factor associated with the overall product, the formation of the product is continued as normal and the next factor is read out from the memory, array or the pointer list and used to form the product.

b) Selection of a Suitable Sequence for Accelerating the Data Processing

A skillful sequence is selected such that if a factor in the product is zero it is very likely that this factor will occur very soon as one of the first factors in the product. As a result, the formation of the overall product can be aborted very soon. The new sequence may be defined here in accordance with the frequency with which the states of the variable occur in the data. A factor which is associated with a very rarely occurring state of a variable is processed first. The sequence in which the factors are processed can thus be defined once before the learning method starts by storing the values of the variables in a correspondingly ordered list.

c) Logarithmic Representation of the Tables

In order to limit as far as possible the calculation complexity of the method mentioned above, a logarithmic presentation of the tables is preferably used in order, for example, to avoid underflow problems. With this function it is possible to replace originally zero elements by a positive value, for example. As a result, complex processing or division of values which are virtually zero and differ from one another by only a small distance is no longer necessary.

d) Avoidance of Increased Summing when Calculating Sufficient Statistics

If the stochastic variables which are allocated to the learning method have a low probability of membership of the specific cluster, a large number of clusters will have the a posteriori weighting of zero in the course of the learning method.

So that the accumulation of the sufficient statistics can also be accelerated in the subsequent step, only clusters which have a weighting which is different from zero are then taken into account in this step.

It is advantageous here to store the clusters which are different from zero in a list, an array or a similar data structure which permits only the elements which are different from zero to be stored.

II. Second Example in an EM Learning Method

a) Clusters with Zero Assignments for a Data Point are not taken into Account

In particular, information indicating which clusters are still permitted in the tables as a result of occurrence of zeros, and which are no longer permitted, is stored here for each data point in an EM learning method from one step of the learning method to the next step.

Where clusters which are given an a posteriori weighting of zero by multiplication by zero are excluded from all further calculations in the first example in order to avoid numerical complexity, in this example intermediate results relating to cluster memberships of individual data points (which clusters are already excluded or are still permissible) from one EM step to the next are also stored in additionally necessary data structures.

b) Storage of a List with References to Relevant Clusters

For each data point or for each input stochastic variable it is firstly possible to store a list or a similar data structure which contain references to the relevant clusters which have been assigned a weighting different from zero for this data point.

Overall, in this example only the permitted clusters are then stored, but for each data point in a data record.

The two examples above can be combined with one another, which permits the aborting when there are “zero” weightings in the inference step, with only the permitted clusters being taken into account according to the second exemplary embodiment in the following EM steps.

A second variant of the EM learning method will be explained in more detail below. It is to be noted that this method is independent of the use of the statistical model which is formed in this way.

Referring to the EM learning method described above it is apparent that missing information does not have to be supplemented for all the variables. The invention has recognized that some of the missing information can be “ignored”. In other words this means that an attempt is not made to find out something about a random variable Y from data in which there is no information about the random variable Y (a node Y), or that an attempt is not made something about the relationships between two random variables Y and X (two nodes Y and X) from data in which there is no information about the random variables Y and X.

As a result, not only is the numerical complexity involved in carrying out the EM learning method significantly reduced, the EM learning method is also made to converge more quickly. An additional advantage can be considered to be the fact that statistical models can be more easily established in a dynamic fashion by means of this procedure, i.e. during the learning process it is more easily possible to supplement variables (nodes) in a network, the directional graph.

It is assumed, as a clear example of the method according to the invention, that a statistical model contains variables which describe which evaluation has been given to a film by a cinema goer. For each film there is a variable with each variable being assigned a plurality of states and with each state representing one evaluation value in each case. For each customer there is a data record in which information indicating which film has received which evaluation value is stored. If a new film is on offer, the evaluation values for this film are often missing at the beginning. By means of the new variant of the EM learning method there is now the possibility that until the new film appears the EM learning method is carried out only with the films which have been known until then, i.e. that the new film is firstly ignored (i.e. generally the new node in the directional graph). Only when the new film appears is a new variable (a new node) added dynamically to the statistical model and the evaluations of the new film taken into account. The convergence of the method in the sense of the log likelihood is still ensured here, but the method converges even more quickly.

Below an explanation will be given of the conditions under which missing information does not need to be taken into account.

The following notation is used to explain the procedure. H designates the concealed node. O={O¹,O², . . . ,O^{M}} designates a set of M observable nodes in the directional graph of the statistical model.

Without restricting the general applicability, a Bayesian probability model will be assumed below which can be factorized according to the following rule:

$$P ( H , \underline{O} ) = P ( H ) {\sum }_{π = 1}^{M} P ( {O}^{π} \vert H ) . \qquad ( 2 )$$

In this context it is to be noted that the described procedure can be applied to any statistical model and is not restricted to a Bayesian probability model, as will also be presented below in detail.

In the text which follows, random variables are designated by upper case letters while an instance of a respective random variable is designated by a lower case letter.

A data record with N data record elements {oᵢ, i=1, . . . N} is assumed, with only some of the observable nodes being actually observed for each data record element. For the i-th data record element it is assumed that the node Xᵢ is observed and that the observation values of the node Yᵢ are missing.

The following therefore applies:
Xᵢ∪Yᵢ=Oᵢ (3)

It is to be noted that a different record of nodes Xᵢ can be observed for each data record element, i.e. that the following applies:
Xᵢ=Xⱼ for i≠j. (4)

The indices for existing nodes are designated by κ, i.e. Xᵢ={Xᵢ^{κ}, κ=1, . . . ,Kᵢ}, and the indices for non-existing nodes are designated by λ, i.e. Yᵢ={Yᵢ^{λ}, λ=1, . . . ,Lᵢ}.

In the case of a Bayesian network, the customary EM learning method has the following steps, as has already been presented above in brief:

1) E Step

The method is started with “empty” tables SS(H) and SS(O^{π},H), i=1, . . . , M (initialized with “zeros” in order to accumulate the estimations (sufficient statistics values) on this basis. The a posteriori distribution P(H|Xᵢ) for the concealed nodes H and the a posteriori composite distribution P(H, Yᵢ^{π}|xᵢ) for each of the non-existing nodes Yᵢ together with the concealed node H are calculated for each data record element oᵢ.

The estimations for the statistical model are accumulated for each data record element i according to the following rules:

$$\begin{matrix}SS ( H ) += {\sum }_{i} P ( H \vert {\underline{x}}_{i} ) , & ( 5 ) \\ SS ( {X}_{i}^{κ} = {x}_{i}^{κ} , H ) += P ( H \vert {\underline{x}}_{i} ) , ∀ existing node {X}_{i}^{κ} , & ( 6 ) \\ SS ( {Y}_{i}^{λ} , H ) += P ( H , {Y}_{i}^{λ} \vert {\underline{x}}_{i} ) , ∀ nonexisting node {Y}_{i}^{λ} . & ( 7 )\end{matrix}$$

The symbol += designates the updating, i.e. the accumulation of the tables for the estimations according to the values of the respective “right-hand side” of the equation.

2) M Step

The parameters for all the nodes are updated in the M step according to the following rules:
P(H)∝SS(H), (8)
P(O^{π}|H)∝SS(O^{π},H), (9)
where the symbol ∝ indicates that the probability tables are to be standardized when transferring SS to P.

According to the EM learning method the expected values are calculated for the nonexisting nodes Yᵢ and updated for these nodes in accordance with the sufficient statistics values according to rule (7).

On the other hand, the calculation and updating of the composite distribution P(H, Yᵢ^{λ}|xᵢ) for all the nodes Yᵢ^{λ}εYᵢ is very complex in terms of calculation. In addition, the updating of the composite distribution P(H, Yᵢ^{λ}|xᵢ is a reason for the slow convergence of the EM learning method if a large portion of information is missing.

It will be assumed that the tables are initialized with random numbers before the EM learning method is started.

In this case, the composite distribution P(H, Yᵢ^{λ}|xᵢ) corresponds essentially to these random numbers in the first step. This means that the initial random numbers are taken into account in the sufficient statistics values according to the ratio of the missing information with respect to the existing information. This means that the initial random numbers in each table are “deleted” only in accordance with the relationship between the missing information and the existing information.

In the text which follows it is proven that in the case of a Bayesian network as a statistical model the step according to rule (7) is not necessary and can thus be omitted or bypassed.

The log likelihood of the Bayesian network as a statistical model is given by:

$$L [ P ] = {\sum }_{i = 1}^{N} log P ( {\underline{x}}_{i} ) . \qquad ( 10 )$$

For freely predefined tables which are standardized in terms of the node H, the following is obtained for the log likelihood:

$$\begin{matrix}L [ P ] = {\sum }_{i = 1}^{N} B ( h \vert {\underline{x}}_{i} ) log P ( {\underline{x}}_{i} ) \\ = {\sum }_{i = 1}^{N} {\sum }_{h} B ( h \vert {\underline{x}}_{i} ) log \frac{P ( {\underline{x}}_{i} , h )}{P ( h \vert {\underline{x}}_{i} )} \\ = {\sum }_{i = 1}^{N} {\sum }_{h} B ( h \vert {\underline{x}}_{i} ) log P ( {\underline{x}}_{i} , h ) - \\ {\sum }_{i = 1}^{N} {\sum }_{h} B ( h \vert {\underline{x}}_{i} ) log P ( h \vert {\underline{x}}_{i} )\end{matrix} \qquad ( 11 )$$

The sum

$${\sum }_{h}$$

designates the sum of all the states h of the node H.

Using the following definitions for R[P,B] and H[P,B]:

$$\begin{matrix}R [ P , B ] = {\sum }_{i = 1}^{N} {\sum }_{h} B ( h \vert {\underline{x}}_{i} ) log P ( {\underline{x}}_{i} , h ) & ( 12 ) \\ H [ P , B ] = {\sum }_{i = 1}^{N} {\sum }_{h} B ( h \vert {\underline{x}}_{i} ) log P ( h \vert {\underline{x}}_{i} ) & ( 13 )\end{matrix}$$

the following is obtained for the log likelihood according to rule (11):
L[P]=R[P,B]−H[P,B]. (14)

The following generally applies:
H[P,B]≦H[P,P], (15)
since H[P,P]−H[P,B] represents the nonnegative cross-entropy between P(h|xᵢ) and B(h|xᵢ).

In the t-th step, the current statistical model is designated by p^{(t)}. A new statistical model p^{(t+1)} is constructed on the basis of the current statistical model P^{(t)} of the t-th step in such a way that the following applies:
R└P^{(t+1)},P^{(t)}┘>R└P^{(t)},P^{(t)}┘. (16)

The following applies:

$$\begin{matrix}L ⌊ {P}^{( t + 1 )} ⌋ = R ⌊ {P}^{( t + 1 )} , B ⌋ - H ⌊ {P}^{( t + 1 )} , B ⌋ \\ = R [ {P}^{( t + 1 )} , {P}^{( t )} ] - H [ {P}^{( t + 1 )} , {P}^{( t )} ] \\ > R [ {P}^{( t )} , {P}^{( t )} ] - H [ {P}^{( t )} , {P}^{( t )} ] \\ = L [ {P}^{( t )} ]\end{matrix} \qquad ( 17 )$$

The first line applies generally for all Bs (compare rule (14)). The second line of the rule (17) applies in particular to the case in which the following is true:
B=P^{(t)}. (18)

The third line applies owing to the rule (15). The last line of rule (17) corresponds in turn to rule (14).

The result of this is that for the case R[P^{(t+1)},P^{(t)}]>R[P^{(t)},P^{(t)}] the following definitely applies:
L[P^{(t+1)}]>L[P^{(t)}]. (19)

Reference is made to the difference from the standard EM learning method [2] in which the R term is defined according to the following rule:

$${R}^{Standard} [ P , B ] = {{\sum }_{i = 1}}^{N} {\sum }_{h , {\underline{y}}_{i}} B ( {\underline{y}}_{i} , h \vert {\underline{x}}_{i} ) log P ( {\underline{x}}_{i} , {\underline{y}}_{i} , h ) . \qquad ( 20 )$$

It is to be noted that in the argument of P and B in the above rule (20) the following variables y also occur, in contrast to the definition corresponding to rules (12) and (13).

A sequence of EM iterations is formed in such a way that the following applies:
R^{Standard}└P^{(t+1)},P^{(t)}┘>R^{Standard}└P^{(t)},P^{(t)}┘. (21)

In the learning method according to the invention, a sequence of EM iterations is formed for a Bayesian network in such a way that the following applies:
R└P^{(t+1)},P^{(t)}┘>R└P^{(t)},P^{(t)}┘. (16)

It will now be shown that the to R, defined according to rule (12), leads to the learning method described above in which rule (7) is bypassed. In the case of a given current statistical model P^{(t)} for an iteration t, the aim of the method is to calculate a new statistical model P^{(t+1)} in the iteration t+1 by R[P,P^{(t)}] being optimized with respect to P. Using the factorization according to rule (2) yields the following:

$$R [ P , {P}^{( t )} ] = {{\sum }^{N}}_{i = 1} {\sum }_{h} {P}^{( t )} ( h \vert {\underline{x}}_{i} ) log P ( h ) + {{\sum }^{N}}_{i = 1} {\sum }_{h} {\sum }_{κ = 1}^{{K}_{i}} {P}^{( t )} ( h \vert {\underline{x}}_{i} ) log P ( {x}_{i}^{κ} \vert h ) . \qquad ( 22 )$$

Optimizing R with respect to the model P leads to the method according to the invention. The first term leads to the standard updating of P(H) according to rules (5) and (7).

By means of

$$S S ( h ) ≡ {\sum }_{i = 1}^{N} {P}^{( t )} ( h \vert {\underline{x}}_{i} ) log P ( h ) \qquad ( 23 )$$

the first term of rule (22) is obtained as

$${\sum }_{h} {\sum }_{i = 1}^{N} {P}^{( t )} ( h \vert {\underline{x}}_{i} ) log P ( h ) = {\sum }_{h} S S ( h ) log P ( h ) , \qquad ( 24 )$$

which corresponds essentially to the cross-entropy between SS(H) and P(H). The optimum P(H) is thus given by SS(H). This corresponds to the M step according to rule (8).

The second term of rule (22) leads to EM updating for the tables of the conditional probabilities P(O^{π}|H), as is described by means of the rules (6) and (9). In order to illustrate this, all the terms which are dependent on P(O^{π}|H) are collected in R. These terms are obtained according to the following rule:

$${\sum }_{h} {{\sum }_{i = 1}^{N}}_{{O}^{π} ∈ {\underline{X}}_{i}} {P}^{( t )} ( h \vert {\underline{x}}_{i} ) log P ( {o}^{π} \vert h ) . \qquad ( 25 )$$

The sum

$${{\sum }_{i = 1}^{N}}_{{O}^{π} ∈ {\underline{X}}_{i}}$$

designates the sum of all the data elements i in the data record, with O^{π} being one of the observed nodes, i.e. at which the following applies: O^{π}∈Xᵢ. (26)

In summary, the above expression (25) can be interpreted as the cross-entropy between P(O^{π}H) and the sufficient statistics values which are accumulated according to rule (6). It is thus not necessary to provide updating according to rule (7). This is due to the sum

$${{\sum }_{i = 1}^{N}}_{{O}^{π} ∈ {\underline{X}}_{i}}$$

in rule (25) or to the sum

$${\sum }_{κ = 1}^{{K}_{i}}$$

in rule (22). This sum takes into account only the observed nodes, in contrast to the definition of R^{Standard} according to rule (20) in which the nonobserved nodes Yᵢ are not taken into account either.

The validity of the procedure for not taking into account nonobserved nodes within the scope of the updating of the sufficient statistics tables is presented below in a more generally valid case, showing that the procedure is not restricted to a so-called Bayesian network.

A set of variables Z={Z¹,Z², . . . ,Z^{M}} is assumed. It is also assumed that the statistical model can be factorized in the following way:

$$P ( \underline{Z} ) = {\prod }_{σ = 1}^{M} P ( {Z}^{σ} \vert \prod [ {Z}^{σ} ] ) , \qquad ( 27 )$$

where π└z^{σ}┘ designates the “parent” nodes of the node Z^{σ} in the Bayesian network. In addition, a data record {zᵢ, i=1, . . . , N} with N data record elements is assumed for each node Z. As already assumed above, only some of the nodes Z are observed in each of the N data record elements in this case also. For the i-th data record element it is assumed that the nodes Xᵢ are observed; the nodes \overline{X}ᵢ are not observed and the following applies:
Z=Xᵢ∪\overline{X}ᵢ (28)

For each of the N data record elements, the nonobserved nodes \overline{X}ᵢ are divided into two subsets Hᵢ and Yᵢ in such a way that none of the nodes in the sets Xᵢ and Hᵢ is a dependent, i.e. successor node (“children” node) of a node in the set Yᵢ. This clearly means that Yᵢ corresponds to a branch in a Bayesian network for which there is no information in the data.

As a result, the composite distributions for the nodes Xᵢ and Hᵢ are obtained according to the following rule:

$$P ( {\underline{X}}_{i} , {\underline{H}}_{i} ) = {\prod }_{X ∈ {\underline{X}}_{i}} P ( X \text{\vert} \prod [ X ] ) {\prod }_{H ∈ {\underline{H}}_{i}} P ( H \text{\vert} \prod [ H ] ) . \qquad ( 29 )$$

1) E Step

For each node Z, tables SS(Z, π[z]) which are initialized with zero values are formed or made available. For each data record element i in the data record, the a posteriori distribution P(Z, π[Z]|Xᵢ=xᵢ) is calculated and the sufficient statistics values are accumulated according to the following rule for each node Z∈Xᵢ and Z∈Hᵢ:
SS(Z, π|Z)+=P(Z, π[Z]|Xᵢ=xᵢ). (30)

The sufficient statistics values of the tables which are assigned to the nodes in \overline{X}ᵢ are not updated.

2) M Step

The parameters (tables) of all the nodes are updated according to the following rule:
P(Z^{σ}|π[Z^{σ}])∝SS(Z^{σ}, π[Z^{σ}]). (31)

The invention can clearly be considered to be the fact that a wide and easy (but at any rate generally approximated) access to the statistics of a database (preferably over the Internet) is provided by forming statistical models for the contents of the database. As a result, the statistical models are automatically dispatched for “remote diagnosis”, for so-called “remote assistance” or for “remote research” via a communications network. In other words “knowledge” in the form of a statistical model is communicated and dispatched. Knowledge is frequently knowledge about the relationships and mutual dependencies in a domain, for example about the dependencies in a process. A statistical model of a domain which is formed from the data of the database is a mapping of all these relationships. In technical terms, the models constitute a common probability distribution of the dimensions of the database and are therefore not restricted to a specific functional definition but rather constitute any dependencies between the dimensions. When compressed to form the statistical model, the knowledge about a domain can be easily handled, dispatched, made available to any desired users etc.

The resolution of the mapping or of the statistical model can be selected in accordance with the requirements of data protection or the requirements of the parties involved.

The following publications are cited in this document:
[1] Christopher M. Bishop, Latent Variable Models, M. I. Jordan (Editor), Learning in Graphical Models, Kulwer, 1998, pages 371-405
[2] M. A. Tanner, Tools for Statistical Inference, Springer, New York, 3^{rd} edition, 1996, pages 64-135
[3] Radford M. Neal and Geoffrey E. Hinton, A View of the EM Algorithm that Justifies Incremental, Sparse and Other Variants, M. I. Jordan (Editor), Learning in Graphical Models, Kulwer, 1998, pages 355-371
[4] D. Heckermann, Bayesian Networks for Data Mining, Data Mining and Knowledge Discovery, pages 79-119, 1997
[5] Reimar Hofmann, Lernen der Struktur nichtlinearer Abhängigkeiten mit graphischen Modellen [Learning of the structure of nonlinear dependencies with graphic models], Dissertation an der Technischen Universität München [Dissertation at the Technical University of Munich], Verlag: dissertation.de, ISBN:3-89825-131-4

1. A method for the computer-aided provision of database information of a first database,
in which, for the first database, a first statistical model is formed which represents the statistical relationships between the data elements contained in the first database,
in which the first statistical model is stored in a server computer,
in which the first statistical model is transmitted from the server computer to a client computer via a communications network,
in which the received, first statistical model is further processed by the client computer.

2. The method as claimed in claim 1, in which an overall statistical model is formed using the first statistical model and data elements of a second database stored in the client computer, which model has at least some of the statistical information contained in the first statistical model and some of the statistical information contained in the second database.

3. The method as claimed in claim 1,
in which, for a second database, a second statistical model is formed which represents the statistical relationships between the data elements contained in the second database,
in which the second statistical model is transmitted to the client computer via the communications network,
in which an overall statistical model, which has at least some of the statistical information contained in the first statistical model and some of the statistical information contained in the second statistical model, is formed by the client computer using the first statistical model and the second statistical model.

4. The method as claimed in claim 3,
in which the second statistical model is stored in a second server computer,
in which the second statistical model is transmitted from the second server computer to the client computer via a communications network.

5. The method as claimed in one of claims 1 to 4, in which at least one of the statistical models is formed by means of a scalable method with which the degree of compression of the statistical model compared to the data elements contained in the respective database can be set.

6. The method as claimed in one of claims 1 to 5, in which at least one of the statistical models is formed by means of an EM learning method or by means of a gradient-based learning method.

7. The method as claimed in one of claims 1 to 6, in which the first database and/or the second database has/have data elements which describe at least one technical system.

8. The method as claimed in claim 7, in which the data elements describing the at least one technical system represent values which are measured at least partially on the technical system and which describe the operating behavior of the technical system.

9. The method for the computer-aided formation of a statistical model of a database which has a plurality of data elements,
in which an EM learning method is carried out on the data elements so that statistical relationships between the data elements are determined for a predefinable, directional graph,
wherein the directional graph has nodes and edges,
wherein the edges describe predefinable, observable database states and non-observable database states,
in which, within the scope of the EM learning method, only the expected values are determined for the observable database states and for the non-observable database states whose parent database states are observable database states.

10. A computer arrangement for the computer-aided provision of database information of a first database,
having a server computer in which a first statistical model which is formed for a first database is stored, wherein the first statistical model represents the statistical relationships of the data elements contained in the first database,
having a client computer which is coupled to the server computer by means of a communications network and which is configured for further processing the first statistical model which is transmitted from the server computer to the client computer via the communications network.

11. The computer arrangement as claimed in claim 10,
in which a second database having data elements is stored in the client computer,
wherein the client computer has a unit for forming an overall statistical model using the first statistical model and the data elements of the second database, wherein the overall statistical model has at least some of the statistical information contained in the first statistical model and some of the statistical information contained in the second database.

12. The computer arrangement as claimed in claim 10,
having a second server computer in which a second statistical model which is formed for a second database is stored, wherein the second statistical model represents the statistical relationships of the data elements contained in the second database,
wherein the client computer is coupled to the second server computer by means of the communications network,
wherein the client computer has a unit for forming an overall statistical model using the first statistical model and the second statistical model, wherein the overall statistical model has at least some of the statistical information contained in the first statistical model and some of the statistical information contained in the second statistical model.
